(19) United States
(12) Patent Application Publication
(10) Pub. No.: US 2026/0122326 A1
(43) Pub. Date: Apr. 30, 2026

(54) VIDEO SUMMARIZATION METHOD, APPARATUS, COMPUTER DEVICE, COMPUTER-READABLE STORAGE MEDIUM AND COMPUTER PROGRAM PRODUCT

(71) Applicant: SHANGHAI HODE INFORMATION TECHNOLOGY CO., LTD., Shanghai (CN)

(72) Inventors: Ying ZHANG, Shanghai (CN); Xinwen ZHANG, Shanghai (CN); Shan CHEN, Shanghai (CN); Tianjiao LI, Shanghai (CN); Junyi WU, Shanghai (CN); Shuwen DAI, Shanghai (CN); Bocheng ZHAO, Shanghai (CN); Jianqiang DING, Shanghai (CN); Yuancheng NI, Shanghai (CN); Lihua HUANG, Shanghai (CN); Xiaojing LIU, Shanghai (CN); Qi WANG, Shanghai (CN)

(21) Appl. No.: 19/324,761

(22) Filed: Sep. 10, 2025

(30) Foreign Application Priority Data
Oct. 29, 2024 (CN) 202411527505.3

(51) Int. Cl. H04N 21/8549; G06F 40/40; H04N 21/431; H04N 21/466; H04N 21/4722

(52) U.S. Cl. CPC H04N 21/8549; G06F 40/40; H04N 21/4316; H04N 21/466; H04N 21/4722

(57) ABSTRACT

The application provides a video summarization method, including: displaying a playback page, wherein the playback page includes a player and a video summary control, the player is configured to play a target video, and the target video includes a plurality of video clips; displaying a video summary area in response to selecting the video summary control, wherein the video summary area includes a first display control; and displaying a video summary list in the video summary area in response to selecting the first display control, wherein the video summary list includes a plurality of video content summaries, and the plurality of video content summaries are in one-to-one correspondence with the plurality of video clips; wherein the video content summary includes a text summary and a picture summary, the picture summary includes a frame image of the corresponding video clip, and the frame image is determined based on the text summary.

### TECHNICAL FIELD

Embodiments of the application relate to the field of artificial intelligence technologies, and in particular, to a video summarization method and apparatus, a computer device, a computer-readable storage medium, and a computer program product.

### BACKGROUND

With continuous development of artificial intelligence technologies, a large language model has been widely used in information extraction, text credibility evaluation, machine translation, and other fields because of a good generalization capability. To help an audience quickly understand video content, the video content can be summarized by using an artificial intelligence technology.

However, currently, summarization for the video content is usually lengthy and difficult to understand, and the audience needs to spend plenty of time in browsing, thereby resulting in reduction in video viewing efficiency.

It should be noted that the foregoing content is not necessarily in the conventional technology, and is not used to limit the patent protection scope of the application.

### SUMMARY

Embodiments of the application provide a video summarization method and apparatus, a computer device, a computer-readable storage medium, and a computer program product, so as to solve or alleviate one or more of the foregoing technical problems.

One aspect of the embodiments of the application provides a video summarization method. The method includes:
displaying a playback page, wherein the playback page includes a player and a video summary control, the player is configured to play a target video, and the target video includes a plurality of video clips;
displaying a video summary area in response to selecting the video summary control, wherein the video summary area includes a first display control; and
displaying a video summary list in the video summary area in response to selecting the first display control, wherein the video summary list includes a plurality of video content summaries, and the plurality of video content summaries are in a one-to-one correspondence with the plurality of video clips;
wherein the video content summary includes a text summary and a picture summary of a corresponding video clip, the picture summary includes a frame image of the corresponding video clip, and the frame image is determined based on the text summary.

Optionally, the video content summary further includes a first time jump control; and the first time jump control and the text summary are obtained by performing the following operations:
obtaining text information of the target video, wherein the text information includes a plurality of subtitles of the target video, and each subtitle has a corresponding time identifier; and
inputting the text information into a pre-trained language model, so as to obtain a plurality of text summaries by using the pre-trained language model; wherein
one text summary corresponds to one video clip, each text summary has a corresponding first time jump control, and the first time jump control is configured to locate a corresponding video clip of the text summary.

Optionally, the video summarization method further includes:
generating a jump instruction in response to selecting a first time jump control of one of the video content summaries; and
executing the jump instruction, wherein the jump instruction is configured to instruct the player to enable the target video to jump to a location indicated by the first time jump control to play.

Optionally, the video summary area further includes a second display control. The method further includes:
displaying a subtitle list in the video summary area in response to selecting the second display control, wherein the subtitle list includes a plurality of subtitles of the target video and a second time jump control corresponding to each subtitle, and the second time jump control is configured to locate a corresponding video clip of the subtitle.

Optionally, the video summarization method further includes:
generating a jump instruction in response to selecting a second time jump control of one of the subtitles; and
executing the jump instruction, wherein the jump instruction is configured to instruct the player to enable the target video to jump to a location indicated by the second time jump control to play.

Optionally, the video summarization method further includes:
determining a corresponding video clip based on the selected second time jump control;
determining a corresponding video content summary based on the corresponding video clip;
generating a first list synchronization instruction based on the corresponding video content summary; and
executing the first list synchronization instruction, wherein the first list synchronization instruction is configured to instruct the video summary area to adjust the video summary list, so as to display the corresponding video content summary at a predetermined location of the video summary list.

Optionally, the video summarization method further includes:
determining a corresponding video clip based on the selected first time jump control;
determining a subtitle of the corresponding video clip based on the corresponding video clip;
generating a second list synchronization instruction based on the subtitle of the corresponding video clip; and
executing the second list synchronization instruction, wherein the second list synchronization instruction is configured to instruct the video summary area to adjust the subtitle list, so as to display the subtitle of the corresponding video clip at a predetermined location of the subtitle list.

Optionally, the frame image is determined based on the text summary, and the method further includes:
determining a corresponding video clip based on the first time jump control of the text summary;
extracting a plurality of frame images based on the corresponding video clip;
determining text feature vectors of the plurality of frame images, and an image feature vector and an aesthetic score that are corresponding to each frame image;
determining a picture-text similarity corresponding to the each frame image based on the text feature vector and the image feature vector corresponding to the frame image; and
determining a target frame image based on the picture-text similarity and the aesthetic score that are corresponding to the each frame image, and determining the target frame image as the picture summary.

Optionally, the determining text feature vectors of the plurality of frame images, and an image feature vector and an aesthetic score that are corresponding to each frame image includes:
inputting the text summary into a pre-trained generative embeddings model, so as to obtain the text feature vectors by using the generative embeddings model;
inputting the plurality of frame images into a pre-trained contrastive language-image model, so as to obtain the image feature vector corresponding to each frame image by using the pre-trained contrastive language-image model; and
inputting the plurality of frame images into a pre-trained aesthetic scoring model, so as to obtain the aesthetic score corresponding to each frame image by using the pre-trained aesthetic scoring model.

Optionally, the player is further configured to display a playback progress bar of the target video, and the video summary area further includes a progress bar linkage switch. The method further includes:
displaying a plurality of video summary nodes on the playback progress bar in response to turning on the progress bar linkage switch, wherein the plurality of video summary nodes are in one-to-one correspondence with the plurality of video clips;
determining a corresponding video clip in response to selecting one of the video summary nodes;
obtaining a corresponding video content summary based on the corresponding video clip; and
displaying the corresponding video content summary based on a display location of the selected video summary node.

Optionally, the displaying a video summary area in response to selecting the video summary control includes:
obtaining the video summary list and the subtitle list in response to selecting the video summary control;
when the video summary list and the subtitle list are obtained, displaying the video summary area, and displaying the video summary list and the subtitle list by using the video summary area; and
when the video summary list and the subtitle list are not obtained, obtaining a basic content list of the target video, wherein the basic content list includes one or more of manuscript information, a comment, and a bullet-screen comment; and displaying the video summary area, and displaying the basic content list by using the video summary area.

Another aspect of the embodiments of the application provides a video summarization apparatus. The apparatus includes:
a first display module, configured to display a playback page, wherein the playback page includes a player and a video summary control, the player is configured to play a target video, and the target video includes a plurality of video clips;
a second display module, configured to display a video summary area in response to selecting the video summary control, wherein the video summary area includes a first display control; and
a third display module, configured to display a video summary list in the video summary area in response to selecting the first display control, wherein the video summary list includes a plurality of video content summaries, and the plurality of video content summaries are in one-to-one correspondence with the plurality of video clips;
wherein the video content summary includes a text summary and a picture summary of a corresponding video clip, the picture summary includes a frame image of the corresponding video clip, and the frame image is determined based on the text summary.

Another aspect of the embodiments of the application provides a computer device, including:
at least one processor; and
a memory communicatively connected to the at least one processor; wherein
the memory stores instructions executed by the at least one processor, and the instructions are executed by the at least one processor to enable the at least one processor to perform the foregoing method.

Another aspect of the embodiments of the application provides a computer-readable storage medium. The computer-readable storage medium stores computer instructions. When the computer instructions are executed by a processor, the foregoing method is implemented.

Another aspect of the embodiments of the application provides a computer program product, including a computer program. When the computer program is executed by a processor, the foregoing method is implemented.

In the embodiments of the application, the foregoing technical solutions may include the following advantages.

The playback page including the player and the video summary control is displayed, and the player may be configured to play the target video including the plurality of video clips. The video summary control is selected, then a video summary area with a built-in first display control may pop up on the playback page. The first display control is selected, then the video summary area may display a video summary list. The video summary list includes the plurality of video content summaries that are in one-to-one correspondence with the plurality of video clips. Each video content summary includes the text summary and the picture summary of the corresponding video clip. The picture summary includes the frame image of the corresponding video clip. The frame image is determined based on the text summary. It may be learned that the embodiments of the application may provide a more intuitive and easily understandable picture summary based on the text summary, and an audience may obtain key video content in a shorter time without spending plenty of time in browsing a lengthy text, thereby effectively improving video viewing efficiency.

### BRIEF DESCRIPTION OF DRAWINGS

The accompanying drawings show examples of the embodiments and constitute a part of the specification, and together with the descriptions of the specification are used to describe example implementations of the embodiments. The illustrated embodiments are merely used for illustrative purposes and are not intended to limit the scope of the claims. In all the accompanying drawings, the same reference numerals refer to similar but not necessarily the same elements.

FIG. 1 is a schematic flowchart of a video summarization method according to Embodiment 1 of the application;

FIG. 2 schematically shows a playback page according to Embodiment 1 of the application;

FIG. 3 schematically shows a video summary area according to Embodiment 1 of the application;

FIG. 4 is a schematic flowchart of obtaining a first time jump control and a text summary according to Embodiment 1 of the application;

FIG. 5 is another schematic flowchart of obtaining a first time jump control and a text summary according to Embodiment 1 of the application;

FIG. 6 is a schematic flowchart of obtaining a picture summary according to Embodiment 1 of the application;

FIG. 7 is a schematic flowchart of substeps of step S604 in FIG. 6;

FIG. 8 is a newly-added schematic flowchart of a video summarization method according to Embodiment 1 of the application;

FIG. 9 schematically shows a first time jump control according to Embodiment 1 of the application;

FIG. 10 schematically shows a subtitle list according to Embodiment 1 of the application;

FIG. 11 is a newly-added schematic flowchart of a video summarization method according to Embodiment 1 of the application;

FIG. 12 schematically shows a second time jump control according to Embodiment 1 of the application;

FIG. 13 is a newly-added schematic flowchart of a video summarization method according to Embodiment 1 of the application;

FIG. 14 is a newly-added schematic flowchart of a video summarization method according to Embodiment 1 of the application;

FIG. 15 is a newly-added schematic flowchart of a video summarization method according to Embodiment 1 of the application;

FIG. 16 schematically shows a progress bar linkage switch according to Embodiment 1 of the application;

FIG. 17 schematically shows a video summary node according to Embodiment 1 of the application;

FIG. 18 schematically shows displaying a corresponding video content summary based on a location of a video summary node according to Embodiment 1 of the application;

FIG. 19 is a schematic flowchart of substeps of step S102 in FIG. 2;

FIG. 20 is a newly-added schematic flowchart of a video summarization method according to Embodiment 1 of the application;

FIG. 21 is a schematic block diagram of a video summarization apparatus according to Embodiment 2 of the application; and

FIG. 22 is a schematic diagram of a hardware architecture of a computer device according to Embodiment 3 of the application.

### DESCRIPTION OF EMBODIMENTS

To make the objectives, technical solutions, and advantages of the application clearer and more comprehensible, the following further describes the application in detail with reference to the accompanying drawings and embodiments. It should be understood that the specific embodiments described herein are merely used to explain the application but are not intended to limit the application. All other embodiments obtained by a person of ordinary skill in the art based on the embodiments of the application without creative efforts shall fall within the protection scope of the application.

It should be noted that the descriptions such as “first” and “second” in the embodiments of the application are merely used for description, and shall not be understood as an indication or implication of relative importance or an implicit indication of a quantity of indicated technical features. Therefore, a feature defined with “first” or “second” may explicitly or implicitly include at least one feature. In addition, the technical solutions in the embodiments may be combined with each other, provided that a person of ordinary skill in the art can implement the combination. When the combination of the technical solutions is contradictory or cannot be implemented, it should be considered that the combination of the technical solutions does not exist and does not fall within the protection scope of the application.

In the descriptions of the application, it should be understood that numerical symbols before steps do not indicate an order of performing the steps, but are merely used to facilitate description of the application and differentiation of each step, and therefore cannot be construed as a limitation on the application.

First, explanations of terms in the application are provided.
AI: Artificial Intelligence.
LLM: Large Language Model, it is a deep learning model obtained by training massive data, and can understand and generate a natural language text.
CLIP: Contrastive Language-image Pre-training model.
BGE: Bilingual Generative Embeddings model, it is capable of converting input text into a high-dimensional embedded representation, such as a text feature vector.
UGC: User-generated Content.

Second, to help those of ordinary skill in the art understand the technical solutions provided in the embodiments of the application, the following describes related technologies.

With continuous development of artificial intelligence technologies, a large language model has been widely used in information extraction, text credibility evaluation, machine translation, and other fields because of a good generalization capability. To help an audience quickly understand video content, the video content can be summarized by using an artificial intelligence technology.

However, currently, summarization for the video content is usually lengthy and difficult to understand, and the audience needs to spend plenty of time in browsing, thereby resulting in reduction in video viewing efficiency.

Therefore, an embodiment of the application provides a video summarization technical solution. In the technical solution, (1) a video title, content, release information, and the like are used as inputs of the LLM to generate a brief description of main content of the video. The large language model is used as one of module to improve efficiency, and a video summarization service is provided to an audience with reference to an attribute of UGC, so that the audience can more efficiently understand main content of the video narration. (2) On the basis of an AI text summary, a picture summary, video jump, and presentation of a chapter summary through linkage with a progress bar (video content summary) are supported. Specifically, visualization and comprehensibility are enhanced by using the picture summary, thereby improving video viewing efficiency. Users can obtain video key content in a shorter time without spending plenty of time in browsing a lengthy text. Tapping, double-tapping, sliding, or hovering over a time-dependent jump control (a first time jump control and a second time jump control) is supported to jump to and play a corresponding video picture. For the users, it is unnecessary to search for target content by means of manual fast forward or backward, and only a time-dependent jump control in a video summary needs to be selected to accurately jump to a part to be viewed, so that a video viewing process is smoother and more efficient. In addition, for a video creator, the creator can better understand a focus of the audience. By analyzing the jumped video content, the creator can know a part of the video that is more popular among users, so as to improve and optimize subsequent creation content in a more targeted manner, and improve attraction of quality of the video. By visually displaying chapter nodes (video summary nodes) of an AI summary on a video playback progress bar, the audience can clearly understand approximate framework and key content distribution of the video, and further improve the video viewing efficiency. For details, see the following.

The following describes the technical solutions of the application by using a plurality of embodiments. It should be noted that these embodiments may be implemented in a plurality of different forms, and should not be construed as limited to the embodiments described herein.

### Embodiment 1

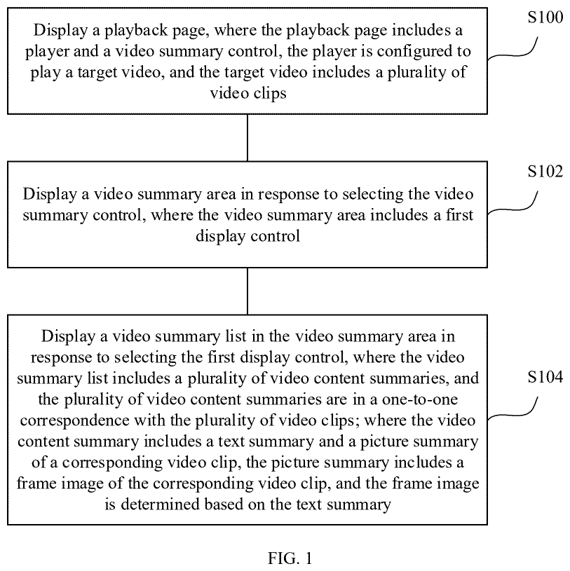

FIG. 1 is a schematic flowchart of a video summarization method according to Embodiment 1 of the application.

As shown in FIG. 1, the video summarization method includes steps S100˜S104.

Step S100: Display a playback page, wherein the playback page includes a player and a video summary control, the player is configured to play a target video, and the target video includes a plurality of video clips.

Step S102: Display a video summary area in response to selecting the video summary control, wherein the video summary area includes a first display control.

Step S104: Display a video summary list in the video summary area in response to selecting the first display control, wherein the video summary list includes a plurality of video content summaries, and the plurality of video content summaries are in one-to-one correspondence with the plurality of video clips. The video content summary includes a text summary and a picture summary of a corresponding video clip, the picture summary includes a frame image of the corresponding video clip, and the frame image is determined based on the text summary.

According to the video summarization method provided in the embodiment, the playback page including the player and the video summary control is displayed, and the player may be configured to play a target video including a plurality of video clips. The video summary control is selected, then a video summary area with a built-in first display control may pop up on the playback page. The first display control is selected, then the video summary area may display a video summary list. The video summary list includes the plurality of video content summaries that are in one-to-one correspondence with the plurality of video clips. Each video content summary includes the text summary and the picture summary of the corresponding video clip. The picture summary includes the frame image of the corresponding video clip. The picture summary is determined based on the text summary. It may be learned that the embodiments of the application may provide a more intuitive and easily understandable picture summary based on the text summary, and an audience may obtain key video content in a shorter time without spending plenty of time in browsing a lengthy text, thereby effectively improving video viewing efficiency.

With reference to FIG. 1, steps in step S100˜S104 and optional other steps are described in detail in the following.

Step S100: Display a playback page, wherein the playback page includes a player and a video summary control, the player is configured to play a target video, and the target video includes a plurality of video clips.

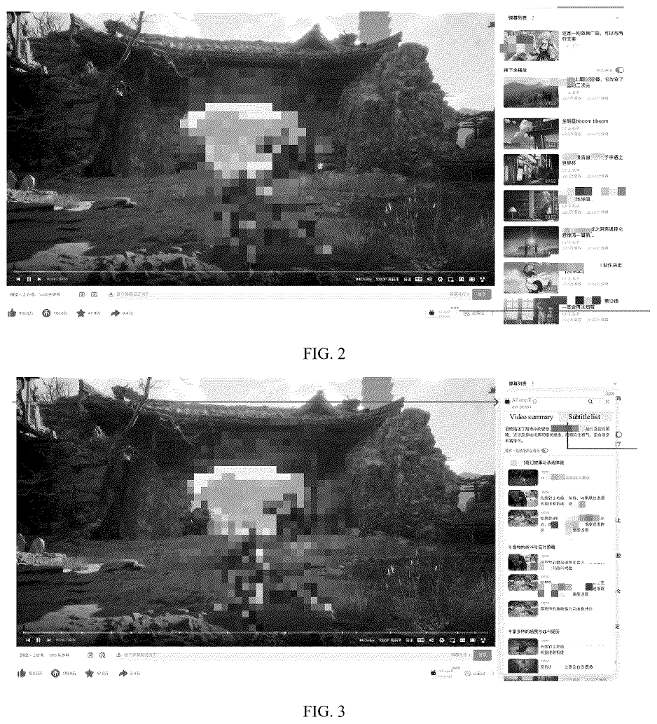

The playback page may be a web page or an application interface. The playback page may include the player and the video summary control. The video summary control may be displayed in the player, or may be independent of the player and is displayed at another location of the playback page, as shown in FIG. 2 (AI small assistant). The player may be configured to play the target video, and the target video may be an on-demand file or a live stream. The target video may include a plurality of video clips, and each video clip may include a plurality of frame images.

Step S102: Display a video summary area in response to selecting the video summary control, wherein the video summary area includes a first display control.

The video summary area can be displayed by selecting the video summary control. The video summary area may be a pop-up page, or may be a part of an existing page (for example, the playback page), and is displayed in an upper layer of the player or at another location independent of the player on the playback page, as shown in FIG. 3. The video summary area may include the first display control, such as “video summary” of FIG. 3.

Step S104: Display a video summary list in the video summary area in response to selecting the first display control, wherein the video summary list includes a plurality of video content summaries, and the plurality of video content summaries are in one-to-one correspondence with the plurality of video clips. The video content summary includes a text summary and a picture summary of a corresponding video clip, the picture summary includes a frame image of the corresponding video clip, and the frame image is determined based on the text summary.

The video summary area can be triggered to display the video summary list by selecting the first display control, as shown in FIG. 3. The video summary list may include the plurality of video content summaries, and one video content summary corresponds to one video clip. Further, a plurality of video content summaries may be further divided into a plurality of chapters based on different topics. Each chapter corresponds to one topic. Each chapter may have one or more video content summaries, so that a more intuitive and clearer video summary can be provided to the audience, thereby effectively optimizing viewing experience. As shown in FIG. 3, the first chapter may include three video content summaries. Each video content summary may include a text summary and a picture summary of a corresponding video clip.

The text summary may include any combination of information such as an overall description, a subject, a key event, an emotional tone, a character, and a scene that are of the corresponding video clip, and may be specifically determined based on an actual requirement. The text summary may be obtained by using technologies such as manual labeling, visual analysis, data mining, and large language models. The following provides an exemplary solution.

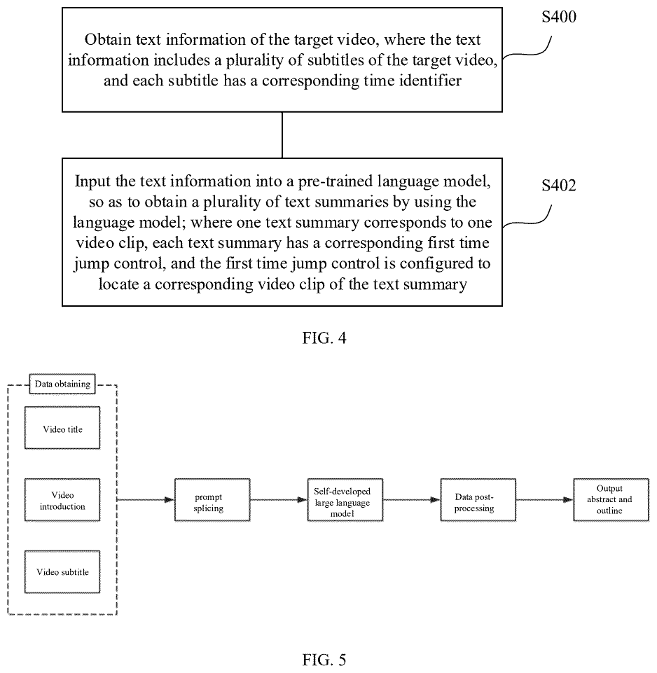

In an optional embodiment, the video content summary may further include a first time jump control, and the first time jump control may be configured to locate a corresponding video clip of the text summary. As shown in FIG. 4, the first time jump control and the text summary may be obtained by the following steps:

Step S400: Obtain text information of the target video, wherein the text information includes a plurality of subtitles of the target video, and each subtitle has a corresponding time identifier.

Step S402: Input the text information into a pre-trained language model, so as to obtain a plurality of text summaries by using the language model. One text summary corresponds to one video clip, each text summary has a corresponding first time jump control, and the first time jump control is configured to locate a corresponding video clip of the text summary.

For example, as shown in FIG. 5, the text information of the target video may be obtained. The text information may include, but is not limited to, a title, an introduction, and a plurality of subtitles of the target video. Each subtitle has a corresponding time identifier. The time identifier may include a start time identifier and/or an end time identifier, which is used to indicate a start time and/or an end time of each subtitle. The collected text information is spliced with a task of the text summary as a prompt to be input into a language model (such as an LLM), and a plurality of text summaries may be obtained. The plurality of text summaries may be in one-to-one correspondence with the plurality of video clips. Each text summary may have the corresponding first time jump control, and the first time jump control may be configured to locate a corresponding video clip of the text summary.

In the embodiment, related information of the target video is understood by using the language model, and the text summary of the target video may be generated with reference to an attribute of UGC, so as to provide a video summarization service for the audience, so that the audience can efficiently understand main content of the video.

In some embodiments, the LLM may further divide a plurality of text summaries into a plurality of chapters based on different subject matters, and generate a summary of each chapter to ultimately form an outline of the target video. The outline can be displayed through the chapter, the text summary, and the first time jump control, for example:

1. Through the 3 Don't Do challenges, allow you to naturally become the person you want to be without the need for self-discipline, embrace the chaos, and allow the chaos to naturally fulfill itself.
00:01—Be disciplined and go with the flow to become the person you want to be.
01:14—The essence of self-discipline is to do what you do not want to do.
04:38—Don't discipline yourself, accept the chaos and let the chaos achieve naturally.
2. The author goes through the chaos caused by the purchase of a pair of sneakers and how to use the chaos to change and fulfill yourself.
05:55—Business marketing breaks the linear thinking that comes with teaching to the test.
06:56—Chaos lets life accomplish what it naturally accomplishes, don't discipline yourself and don't be challenged.
09:20—Use the source of chaos and let life fulfill you naturally.
3. The Don't Do Challenge in Chaos Theory as well as the advantages and disadvantages of random behavior and self-discipline emphasize that only by accepting chaos in an uncertain world can one make progress. 11:51—Don't try to control yourself, and random behavior can lead to new perceptions.
13:48—Passive random behavior can also bring unexpected rewards.
15:57—In the business world, self-discipline requires acceptance of randomness and chaos.

In the embodiment, the language model may divide a plurality of text summaries into a plurality of chapters based on a subject, and generate a chapter summary, so that a structure of the video summary can be optimized and convenient for the audience to navigate and understand, and the video viewing efficiency can be effectively improved.

In some embodiments, the LLM may further generate an abstract of the target video, and the abstract may be an overall description of the target video. The abstract may be displayed in the video summary area, and the video summary control may be displayed in the video summary list (as shown in FIG. 3), or may be displayed at another location in the video summary area independent of the video summary list.

The abstract may be an entire paragraph of text, for example:

The video tells a story of a class reunion ten years later, due to the busy work schedules of 5 people and the absence of 5 people from abroad, only 12 out of the 22 members in the class attended the reunion. Despite the high per capita income among the 22 classmates, after the reunion, they begin to realize the sense of loss brought about by the fact that time passes like a white horse.

In the embodiment, the LLM may generate a video abstract and flexibly display the video abstract, thereby further improving efficiency and viewing experience of the audience in obtaining key video information.

The plurality of foregoing embodiments describe how to obtain the text summary. The picture summary may be determined based on the text summary. The following provides an exemplary introduction for the picture summary and a method for obtaining the picture summary.

The picture summary may be a representative frame image in a corresponding video clip, and the picture summary may be selected from a plurality of image frames of the corresponding video clip based on the text summary. For example, multi-level analysis is performed on the text summary, and the picture summary is determined based on information such as emotion, context, and a subject that are obtained by the analysis. The following provides an exemplary solution.

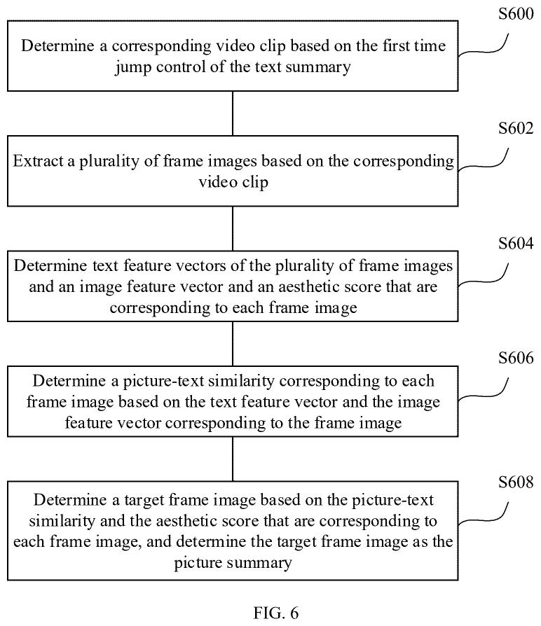

In an optional embodiment, as shown in FIG. 6, the picture summary may be obtained by using the following steps:
Step S600: Determine a corresponding video clip based on the first time jump control of the text summary.
Step S602: Extract a plurality of frame images based on the corresponding video clip.
Step S604: Determine text feature vectors of the plurality of frame images, and an image feature vector and an aesthetic score that are corresponding to each frame image.
Step S606: Determine a picture-text similarity corresponding to each frame image based on the text feature vector and the image feature vector corresponding to the frame image.
Step S608: Determine a target frame image based on the picture-text similarity and the aesthetic score that are corresponding to each frame image, and determine the target frame image as the picture summary.

For example, for each text summary, a corresponding picture summary may be obtained in the following manner. Specifically, the corresponding video clip may be determined from the plurality of video clips of the target video based on time carried in the first time jump control of the text summary. Frame extraction is performed based on the corresponding video clip, so that the plurality of frame images can be obtained. Feature extraction is performed on each frame image to obtain an image feature vector corresponding to the frame image. The image feature vector may reflect information such as content, a structure, and semantics of the frame image. The aesthetic score corresponding to each frame image may be obtained by performing aesthetic scoring on the frame image. The aesthetic score may reflect an aesthetic quality of the frame image in terms of composition, colors, clarity, and the like. Feature extraction may be performed on the text summary to determine text feature vectors of the plurality of frame images. The text feature vector may reflect information such as semantics, grammar, and the like of the text summary. For each frame image, similarity measurement may be performed based on the text feature vector and an image feature vector corresponding to the text feature vector, so as to obtain a corresponding picture-text similarity. The picture-text similarity may reflect similarity between the frame image and the text summary. A final score of each frame image may be obtained by performing weighting, summing, and sorting on the picture-text similarity and the aesthetic score of the frame image. Respective weights of the picture-text similarity and the aesthetic score may be set based on an actual requirement, and may be dynamically adjusted. For example, a weight of the aesthetic score may be increased to select a frame image with a better visual effect as a picture summary. If the target is to adapt the picture summary as much as possible to the text summary, the weight of the picture-text similarity can be increased. A frame image with a highest score may be selected as a target frame image, and the target frame image may be used as the picture summary.

In the embodiment, the picture summary may be obtained based on AI text summary. By using the picture summary, visualization and comprehensibility of information can be enhanced, and video viewing efficiency can be improved. The audience can obtain video key content in a shorter time without spending plenty of time in browsing a lengthy text.

The text feature vector, the image feature vector, and the aesthetic score may be obtained by module of manual labeling, a conventional processing algorithm, or a deep learning model. The following provides an exemplary solution.

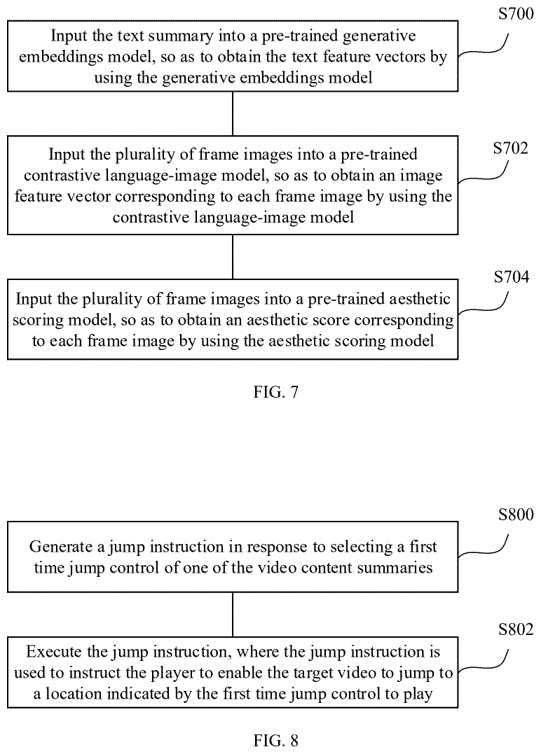

In an optional embodiment, as shown in FIG. 7, step S604 may include:
Step S700: Input the text summary into a pre-trained generative embeddings model, so as to obtain the text feature vectors by using the generative embeddings model.
Step S702: Input the plurality of frame images into a pre-trained contrastive language-image model, so as to obtain an image feature vector corresponding to each frame image by using the contrastive language-image model.
Step S704: Input the plurality of frame images into a pre-trained aesthetic scoring model, so as to obtain an aesthetic score corresponding to each frame image by using the aesthetic scoring model.

For example, the text summary may be input into the pre-trained bilingual generative embeddings (BGE) model to calculate the text feature vector by using the BGE model. The bilingual generative embeddings model is applicable to two language scenarios, such as Chinese and English. Certainly, a specific language may be set according to an actual requirement. The plurality of frame images may be input into the pre-trained contrastive language-image (CLIP) model to calculate the image feature vector of each frame image by using the CLIP model. The aesthetic score of each frame image may also be obtained by scoring the frame image by using the pre-trained aesthetic scoring model.

In the embodiment, comprehensive and efficient multi-modal feature extraction can be implemented by using the BGE model, the CLIP model, and the aesthetic scoring model, so as to improve image-text understanding of video content and improve precision of similarity measurement.

The plurality of foregoing embodiments describe how to display video summary content. The following describes how to interact with video summary content by using multiple embodiments to further improve video viewing efficiency.

In an optional embodiment, as shown in FIG. 8, the video summarization method may further include:
Step S800: Generate a jump instruction in response to selecting a first time jump control of one of the video content summaries.
Step S802: Execute the jump instruction, wherein the jump instruction is used to instruct the player to enable the target video to jump to a location indicated by the first time jump control to play.

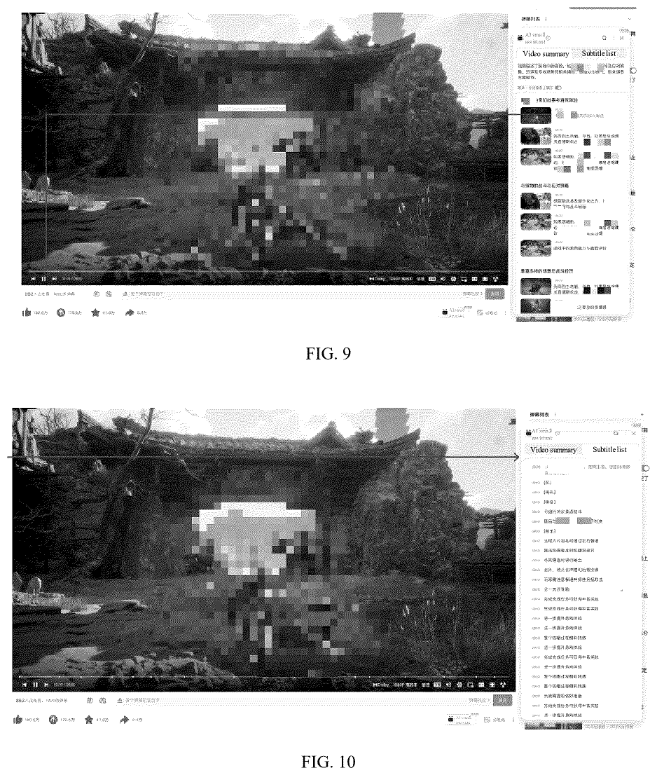

For example, post-processing may be performed on the output of the LLM, the output is converted into a standard format that can be jumped to, and displayed to the audience by using a video summary list. In response to the first time jump control of any video content summary in the video summary list being selected, the jump instruction may be generated and executed, so as to instruct the player to enable the target video to jump to the location indicated by the selected first time jump control to play, as shown in FIG. 9.

In the embodiment, supporting the click of the time jump control to jump to play the corresponding video screen can make video viewing more smoother and efficient.

In an optional embodiment, the video summary area may further include a second display control (“subtitle list” in FIG. 3). The video summarization method may further include: displaying a subtitle list in the video summary area in response to selecting the second display control, wherein the subtitle list includes a plurality of subtitles of the target video and a second time jump control corresponding to each subtitle, and the second time jump control is configured to locate a corresponding video clip of the subtitle.

For example, the second display control is selected, then the subtitle list may be displayed in the video summary area. The subtitle list may include the plurality of subtitles of the target video, and each subtitle may include a corresponding second time jump control. The second time jump control may be configured to locate a corresponding video clip of a subtitle, as shown in FIG. 10. It may be learned that in the video summary area, by setting the first display control and the second display control, switching display of the video summary list and the subtitle list can be implemented, thereby reducing space occupation on the playback page. Certainly, the video summary area may further display the video summary list and the subtitle list at the same time, which is not limited herein.

In the embodiment, the subtitle list may be displayed by using the video summary area, which can provide more detailed information about the target video, enhance understanding, help the audience obtain a specific conversation of the target video, and improve video viewing experience.

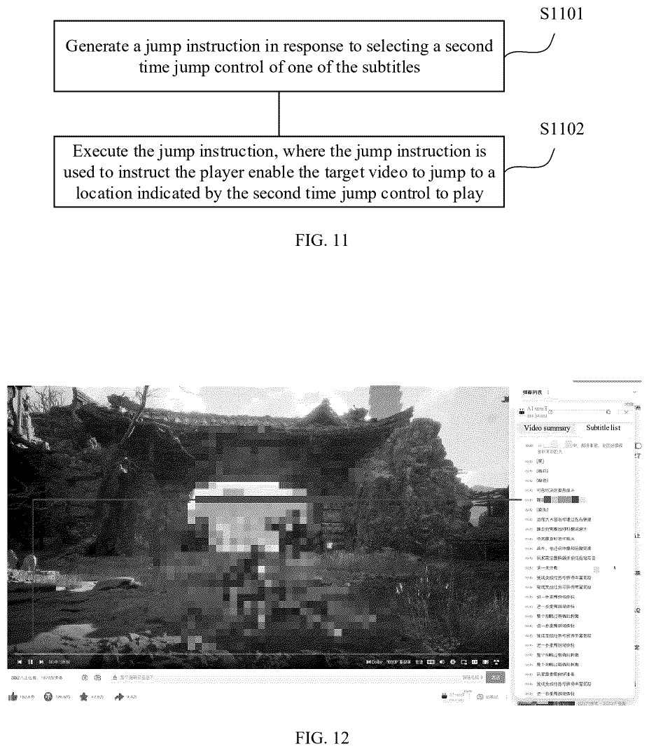

In an optional embodiment, as shown in FIG. 11, the video summarization method may further include:
Step S1101: Generate a jump instruction in response to selecting a second time jump control of one of the subtitles.
Step S1102: Execute the jump instruction, wherein the jump instruction is used to instruct the player to enable the target video to jump to a location indicated by the second time jump control to play.

For example, a time identifier of each subtitle may be converted into a standard format that can be jumped to, that is, the second time jump control, and is displayed to the audience by using the subtitle list. The jump instruction may be generated and executed in response to selecting the second time jump control of any subtitle in the video summary list, so as to instruct the player to enable the target video to jump to a location indicated by the selected second time jump control to play, as shown in FIG. 12.

In the embodiment, tapping of the second time jump control is supported to accurately jump to a video part to be viewed. For the audience, it is not necessary to manually fast forward or backward to find the target content, so as to obtain smooth and efficient video viewing experience.

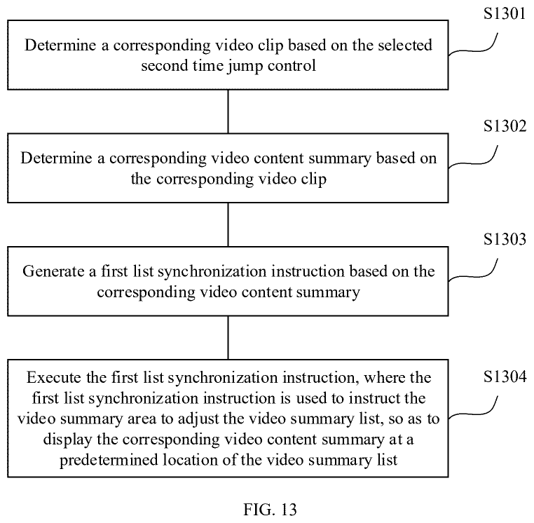

In an optional embodiment, as shown in FIG. 13, the video summarization method may further include:
Step S1301: Determine a corresponding video clip based on the selected second time jump control.
Step S1302: Determine a corresponding video content summary based on the corresponding video clip.
Step S1303: Generate a first list synchronization instruction based on the corresponding video content summary.
Step S1304: Execute the first list synchronization instruction, wherein the first list synchronization instruction is used to instruct the video summary area to adjust the video summary list, so as to display the corresponding video content summary at a predetermined location of the video summary list.

For example, the corresponding video clip may be determined based on the selected second time jump control. Based on the corresponding video clip, the corresponding video content summary may be located, and the first list synchronization instruction is generated and executed. The first list synchronization instruction may be used to instruct the video summary area to adjust (for example, scroll up and down) the video summary list until the corresponding video content summary is adjusted to the predetermined location in the video summary list. The predetermined location may be a top, a middle, or the like of the video summary list to synchronously highlight the corresponding video content summary. The predetermined location can be set as required.

In the embodiment, the first list synchronization instruction is generated based on the selected second time jump control, so that the video summary list can be accurately adjusted, and display progress of the video summary list and display progress of the subtitle list are aligned, thereby further optimizing viewing experience.

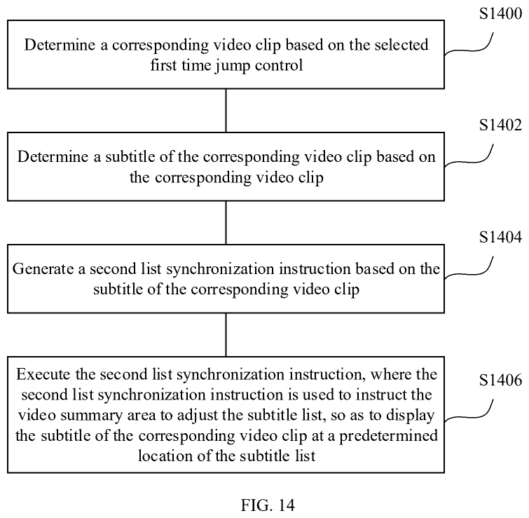

In an optional embodiment, as shown in FIG. 14, the video summarization method may further include:
Step S1400: Determine a corresponding video clip based on the selected first time jump control.
Step S1402: Determine a subtitle of the corresponding video clip based on the corresponding video clip.
Step S1404: Generate a second list synchronization instruction based on the subtitle of the corresponding video clip.
Step S1406: Execute the second list synchronization instruction, wherein the second list synchronization instruction is used to instruct the video summary area to adjust the subtitle list, so as to display the subtitle of the corresponding video clip at a predetermined location of the subtitle list.

For example, the corresponding video clip may be determined based on the selected first time jump control. Based on the corresponding video clip, a corresponding subtitle may be located, and the second list synchronization instruction is generated and executed. The second list synchronization instruction may be used to instruct the video summary area to adjust the subtitle list until the corresponding subtitle is adjusted to the predetermined location of the subtitle list. The predetermined location may be a top, a middle, or the like of the subtitle list to highlight the corresponding subtitle synchronously. The predetermined location can be set as required.

In the embodiment, the second list synchronization instruction is generated based on the selected first time jump control, so that the subtitle list can be accurately adjusted, and display progress of the subtitle list and display progress of the video summary list are aligned, thereby further optimizing viewing experience.

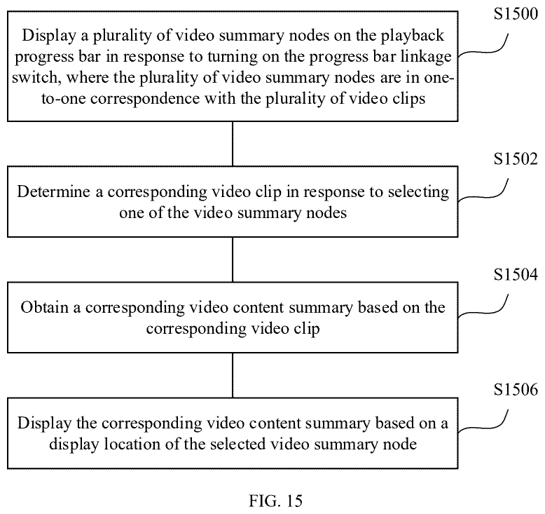

In an optional embodiment, the player may be further configured to display a playback progress bar (as shown in FIG. 3) of the target video, and the video summary area may further include a progress bar linkage switch (as shown in FIG. 3, “key points are displayed on the progress bar”). Correspondingly, as shown in FIG. 15, the video summarization method may further include:
Step S1500: Display a plurality of video summary nodes on the playback progress bar in response to turning on the progress bar linkage switch, wherein the plurality of video summary nodes are in one-to-one correspondence with the plurality of video clips.
Step S1502: Determine a corresponding video clip in response to selecting one of the video summary nodes.
Step S1504: Obtain a corresponding video content summary based on the corresponding video clip.
Step S1506: Display the corresponding video content summary based on a display location of the selected video summary node.

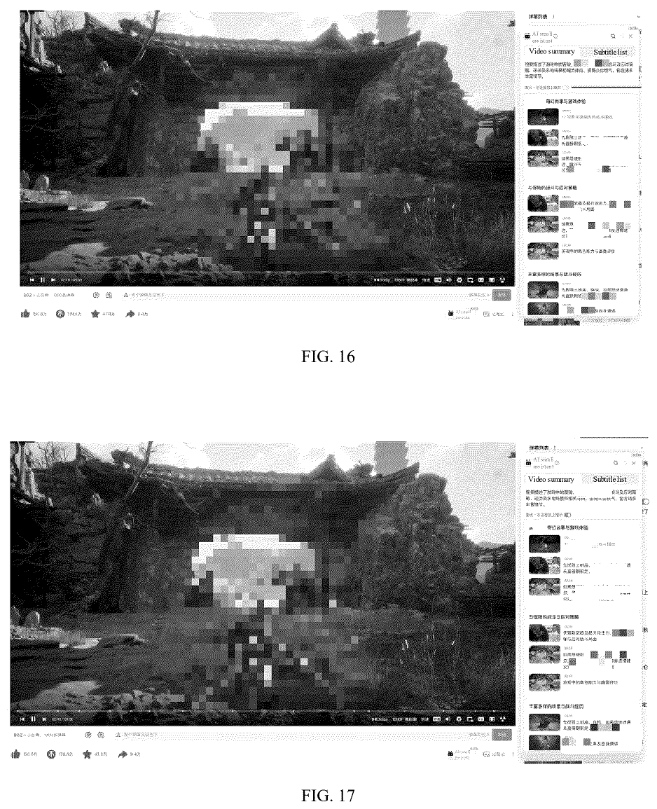

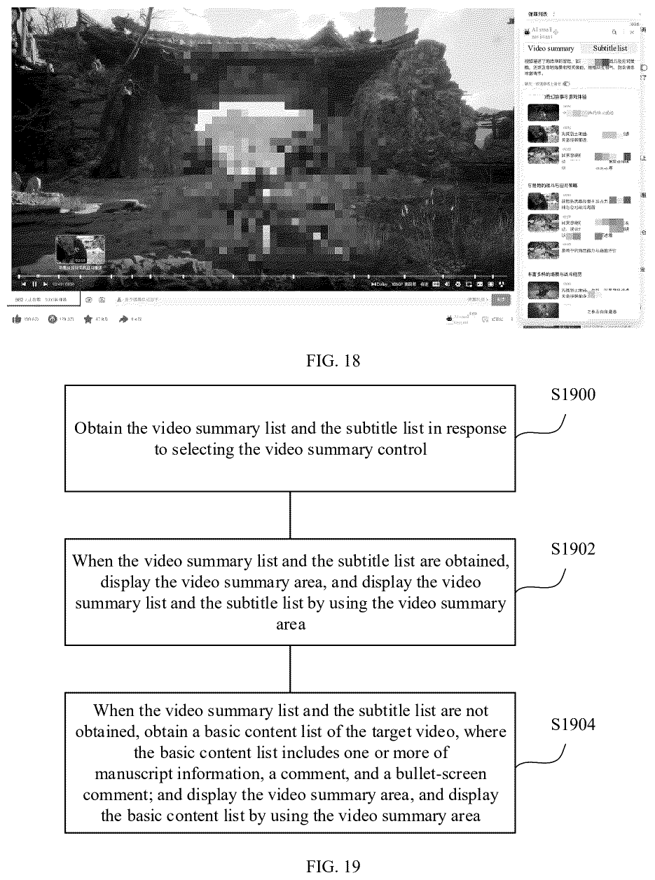

For example, the audience may turn on the progress bar linkage switch, and the playback progress bar may correspondingly display the plurality of video summary nodes, as shown in FIG. 16 and FIG. 17. When it is detected that any video summary node is selected (for example, a mouse hovers over the video summary node for more than a preset time, tap, double taps, or slide), and the corresponding video clip may be obtained. The corresponding video content summary may be obtained based on the corresponding video clip and displayed above the selected video summary node, as shown in FIG. 18.

In the embodiment, the video content summary is supported to be visually displayed on the playback progress bar of the target video, and the audience may directly obtain an approximate framework and key content distribution of the target video on the playback progress bar, thereby greatly improving video viewing efficiency.

In an optional embodiment, as shown in FIG. 19, step S102 may include:
Step S1900: Obtain the video summary list and the subtitle list in response to selecting the video summary control.
Step S1902: when the video summary list and the subtitle list are obtained, display the video summary area, and display the video summary list and the subtitle list by using the video summary area.
Step S1904: when the video summary list and the subtitle list are not obtained, obtain a basic content list of the target video, wherein the basic content list includes one or more of manuscript information, a comment, and a bullet-screen comment; and display the video summary area, and display the basic content list by using the video summary area.

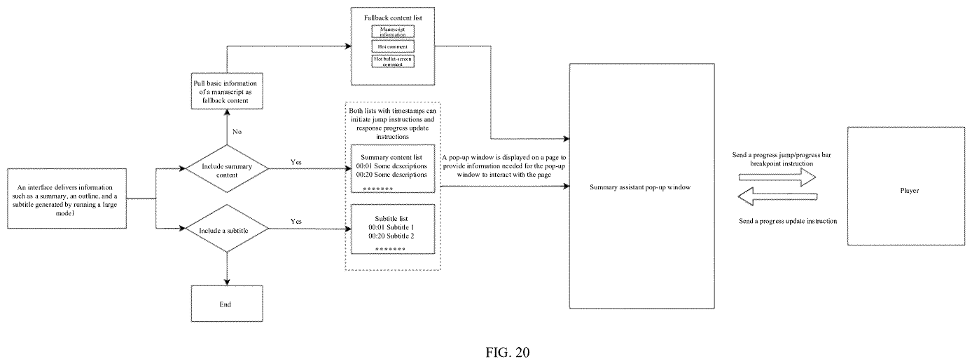

For example, as shown in FIG. 20, when the audience selects the video summary control, an interface may be invoked to obtain a running result (a text summary, an abstract, an outline, and the like) of the LLM and related information (such as a subtitle) of the target video, in order to obtain the video summary list and the subtitle list. In a case that the foregoing content is not obtained, the basic content list of the target video may be obtained from a preset manuscript basic information library. The basic content list may be any combination of manuscript information, hot comments, and hot bullet-screen comments of the target video. Displaying the basic content list through the video summary area can still provide valuable information to the audience, thereby ensuring that the viewing experience is not affected, and enhancing availability and attractiveness of content. In a case that the video summary list and the subtitle list are obtained, display may be performed by using the video summary area.

In the embodiment, in a case that the video summary and the subtitle cannot be obtained, the basic content list is displayed to ensure that viewing experience is not affected.

### Embodiment 2

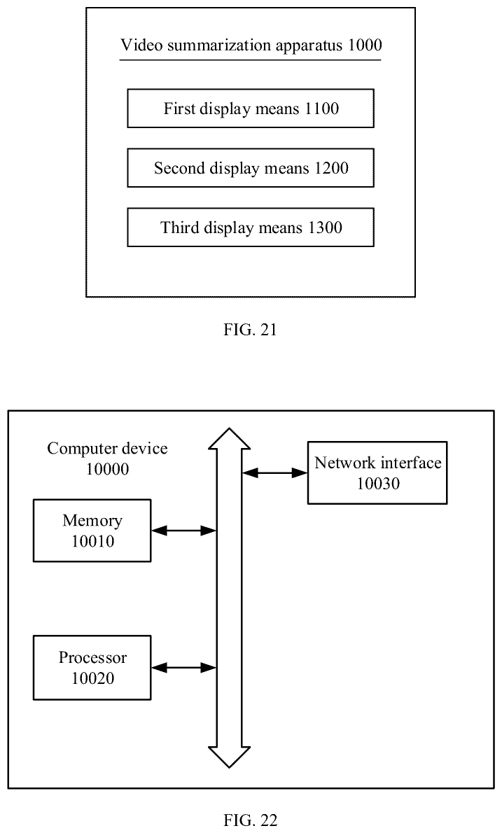

FIG. 21 is a schematic block diagram of a video summarization apparatus according to Embodiment 2 of the application. The apparatus may be divided into one or more program modules. The one or more program modules are stored in a storage medium and executed by one or more processors, so as to complete the embodiment of the application. The program module in the embodiment of the application is a series of computer program instruction segments that can be used to complete a specific function. The following specifically describes a function of each program module in the embodiment. As shown in FIG. 21, the apparatus 1000 may include a first display module 1100, a second display module 1200, and a third display module 1300.

The first display module 1100 is configured to display a playback page, wherein the playback page includes a player and a video summary control, the player is configured to play a target video, and the target video includes a plurality of video clips.

The second display module 1200 is configured to display a video summary area in response to selecting the video summary control, wherein the video summary area includes a first display control.

The third display module 1300 is configured to display a video summary list in the video summary area in response to selecting the first display control, wherein the video summary list includes a plurality of video content summaries, and the plurality of video content summaries are in one-to-one correspondence with the plurality of video clips.

The video content summary includes a text summary and a picture summary of a corresponding video clip, the picture summary includes a frame image of the corresponding video clip, and the frame image is determined based on the text summary.

In an optional embodiment, the video content summary further includes a first time jump control. The first time jump control and the text summary are obtained by performing the following operations:
obtaining text information of the target video, wherein the text information includes a plurality of subtitles of the target video, and each subtitle has a corresponding time identifier; and
inputting the text information into a pre-trained language model, so as to obtain a plurality of text summaries by using the language model;
wherein one text summary corresponds to one video clip, each text summary has a corresponding first time jump control, and the first time jump control is configured to locate a corresponding video clip of the text summary.

In an optional embodiment, the apparatus 1000 is further configured to:
generate a jump instruction in response to selecting a first time jump control of one of the video content summaries; and
execute the jump instruction, wherein the jump instruction is used to instruct the player to enable the target video to jump to a location indicated by the first time jump control to play.

In an optional embodiment, the video summary area further includes a second display control. The apparatus 1000 is further configured to:
display a subtitle list in the video summary area in response to selecting the second display control, wherein the subtitle list includes a plurality of subtitles of the target video and a second time jump control corresponding to each subtitle, and the second time jump control is configured to locate a corresponding video clip of the subtitle.

In an optional embodiment, the apparatus 1000 is further configured to:
generate a jump instruction in response to selecting a second time jump control of one of the subtitles; and
execute the jump instruction, wherein the jump instruction is used to instruct the player to enable the target video to jump to a location indicated by the second time jump control to play.

In an optional embodiment, the apparatus 1000 is further configured to:
determine a corresponding video clip based on the selected second time jump control;
determine a corresponding video content summary based on the corresponding video clip;
generate a first list synchronization instruction based on the corresponding video content summary; and
execute the first list synchronization instruction, wherein the first list synchronization instruction is used to instruct the video summary area to adjust the video summary list, so as to display the corresponding video content summary at a predetermined location of the video summary list.

In an optional embodiment, the apparatus 1000 is further configured to:
determine a corresponding video clip based on the selected first time jump control;
determine a subtitle of the corresponding video clip based on the corresponding video clip;
generate a second list synchronization instruction based on the subtitle of the corresponding video clip; and
execute the second list synchronization instruction, wherein the second list synchronization instruction is used to instruct the video summary area to adjust the subtitle list, so as to display the subtitle of the corresponding video clip at a predetermined location of the subtitle list.

In an optional embodiment, the frame image is determined based on the text summary, and the apparatus 1000 is further configured to:
determine a corresponding video clip based on the first time jump control of the text summary;
extract a plurality of frame images based on the corresponding video clip;
determine text feature vectors of the plurality of frame images, and an image feature vector and an aesthetic score that are corresponding to each frame image;
determine a picture-text similarity corresponding to each frame image based on the text feature vector and the image feature vector corresponding to the frame image; and
determine a target frame image based on the picture-text similarity and the aesthetic score that are corresponding to each frame image, and determine the target frame image as the picture summary.

In an optional embodiment, the determining text feature vectors of the plurality of frame images, and an image feature vector and an aesthetic score that are corresponding to each frame image includes:
inputting the text summary into a pre-trained generative embeddings model, so as to obtain the text feature vectors by using the generative embeddings model;
inputting the plurality of frame images into a pre-trained contrastive language-image model, so as to obtain the image feature vector corresponding to each frame image by using the contrastive language-image model; and
inputting the plurality of frame images into a pre-trained aesthetic scoring model, so as to obtain the aesthetic score corresponding to each frame image by using the aesthetic scoring model.

In an optional embodiment, the player is further configured to display a playback progress bar of the target video, and the video summary area further includes a progress bar linkage switch. The apparatus 1000 is further configured to:
display a plurality of video summary nodes on the playback progress bar in response to turning on the progress bar linkage switch, wherein the plurality of video summary nodes are in one-to-one correspondence with the plurality of video clips;
determine a corresponding video clip in response to selecting one of the video summary nodes;
obtain a corresponding video content summary based on the corresponding video clip; and
display the corresponding video content summary based on a display location of the selected video summary node.

In an optional embodiment, the displaying a video summary area in response to selecting the video summary control includes:
obtaining the video summary list and the subtitle list in response to selecting the video summary control;
when the video summary list and the subtitle list are obtained, displaying the video summary area, and displaying the video summary list and the subtitle list by using the video summary area; and
when the video summary list and the subtitle list are not obtained, obtaining a basic content list of the target video, wherein the basic content list includes one or more of manuscript information, a comment, and a bullet-screen comment; and displaying the video summary area, and displaying the basic content list by using the video summary area.

### Embodiment 3

FIG. 22 is a schematic diagram of a hardware architecture of a computer device 10000 suitable for implementing a video summarization method according to Embodiment 3 of the application. In some embodiments, the computer device 10000 may be a terminal device such as a smartphone, a wearable device, a tablet computer, a personal computer, a vehicle-mounted terminal, a game console, a virtual device, a workbench, a digital assistant, a set-top box, or a robot. In some other embodiments, the computer device 10000 may be a rack server, a blade server, a tower server, a cabinet server (including an independent server, or a server cluster including a plurality of servers), or the like. As shown in FIG. 22, the computer device 10000 at least includes, but is not limited to, a memory 10010, a processor 10020, and a network interface 10030 that can be communicatively connected to each other by using a system bus.

The memory 10010 includes at least one type of computer-readable storage medium. The readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the memory 10010 may be an internal storage module of the computer device 10000, for example, a hard disk or an internal memory of the computer device 10000. In some other embodiments, the memory 10010 may alternatively be an external storage device of the computer device 10000, for example, a plug-in hard disk, a smart media card (SMC), a secure digital (SD) card, or a flash card that is disposed on the computer device 10000. Certainly, the memory 10010 may alternatively include both an internal storage module of the computer device 10000 and an external storage device of the computer device 10000. In the embodiment, the memory 10010 is usually configured to store an operating system and various types of application software that are installed on the computer device 10000, for example, program code of the video summarization method. In addition, the memory 10010 may be further configured to temporarily store various types of data that have been output or are to be output.

In some embodiments, the processor 10020 may be a central processing unit (CPU), a controller, a microcontroller, a microprocessor, or another data processing chip. The processor 10020 is usually configured to control an overall operation of the computer device 10000, for example, perform control and processing related to data exchange or communication performed by the computer device 10000. In the embodiment, the processor 10020 is configured to run program code stored in the memory 10010 or process data.

The network interface 10030 may include a wireless network interface or a wired network interface, and the network interface 10030 is usually configured to establish a communication link between the computer device 10000 and another computer device. For example, the network interface 10030 is configured to: connect the computer device 10000 to an external terminal by using a network, and establish a data transmission channel, a communication link, and the like between the computer device 10000 and the external terminal. The network may be a wireless or wired network such as an Intranet, an Internet, a global system for mobile communications (GSM), a wideband code division multiple access (WCDMA), a 4G network, a 5G network, Bluetooth, or Wi-Fi.

It should be noted that FIG. 22 shows only a computer device with the components 10010-10030. However, it should be understood that implementation of all the shown components is not required, and more or fewer components may alternatively be implemented.

In the embodiment, the video summarization method stored in the memory 10010 may be further divided into one or more program module to be executed by one or more processors (the processor 10020), so as to complete the embodiment of the application.

### Embodiment 4

An embodiment of the application further provides a computer-readable storage medium. The computer-readable storage medium stores a computer program therein. When the computer program is executed by a processor, the steps of the video summarization method in the embodiments are implemented.

In the embodiment, the computer-readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the computer-readable storage medium may be an internal storage unit of a computer device, for example, a hard disk or an internal memory of the computer device. In some other embodiments, the computer-readable storage medium may alternatively be an external storage device of the computer device, for example, a removable hard disk, a smart media card (SMC), a secure digital (SD) card, or a flash card that is disposed on the computer device. Certainly, the computer-readable storage medium may alternatively include both an internal storage unit of the computer device and an external storage device of the computer device. In the embodiment, the computer-readable storage medium is generally configured to store an operating system and various application software that are installed on the computer device, for example, program code of the video summarization method in the embodiments. In addition, the computer-readable storage medium may be further configured to temporarily store various types of data that have been output or are to be output.

### Embodiment 5

An embodiment of the application further provides a computer program product, including a computer program. The computer program is executed by a processor to implement the method in the foregoing embodiment.

Clearly, a person skilled in the art should understand that the foregoing modules or steps in the embodiments of the application may be implemented by using a general computer device. The modules or steps may be integrated into a single computer device or distributed in a network including a plurality of computer device. Optionally, the modules or steps may be implemented by using program code that can be executed by the computer device. Therefore, the modules or steps may be stored in a storage apparatus for execution by the computer device. In addition, in some cases, the shown or described steps may be performed in an order different from the order herein. Alternatively, the modules or steps are separately made into integrated circuit module, or a plurality of modules or steps in the modules or steps are made into a single integrated circuit module for implementation. In this way, a combination of any specific hardware and software is not limited in the embodiments of the application.

It should be noted that the foregoing descriptions are merely preferred embodiments of the application, and are not intended to limit the patent protection scope of the application. Any equivalent structure or equivalent procedure change made based on the content of the specification and the accompanying drawings of the application is directly or indirectly applied to other related technical fields, and shall fall within the patent protection scope of the application.

What is claimed is:

1. A video summarization method, comprising:
displaying a playback page, wherein the playback page comprises a player and a video summary control, the player is configured to play a target video, and the target video comprises a plurality of video clips;
displaying a video summary area in response to selecting the video summary control, wherein the video summary area comprises a first display control; and
displaying a video summary list in the video summary area in response to selecting the first display control, wherein the video summary list comprises a plurality of video content summaries, and the plurality of video content summaries are in a one-to-one correspondence with the plurality of video clips;
wherein the video content summary comprises a text summary and a picture summary of a corresponding video clip, the picture summary comprises a frame image of the corresponding video clip, and the frame image is determined based on the text summary.

2. The method according to claim 1, wherein the video content summary further comprises a first time jump control; and the first time jump control and the text summary are obtained by performing the following operations:
obtaining text information of the target video, wherein the text information comprises a plurality of subtitles of the target video, and each subtitle has a corresponding time identifier; and
inputting the text information into a pre-trained language model, so as to obtain a plurality of text summaries by using the pre-trained language model;
wherein one text summary corresponds to one video clip, each text summary has a corresponding first time jump control, and the first time jump control is configured to locate a corresponding video clip of the text summary.

3. The method according to claim 2, further comprising:
generating a jump instruction in response to selecting a first time jump control of one of the video content summaries; and
executing the jump instruction, wherein the jump instruction is configured to instruct the player to enable the target video to jump to a location indicated by the first time jump control to play.

4. The method according to claim 3, wherein the video summary area further comprises a second display control; and the method further comprises:
displaying a subtitle list in the video summary area in response to selecting the second display control, wherein the subtitle list comprises a plurality of subtitles of the target video and a second time jump control corresponding to each subtitle, and the second time jump control is configured to locate a corresponding video clip of the subtitle.

5. The method according to claim 4, further comprising:
generating a jump instruction in response to selecting a second time jump control of one of the subtitles; and
executing the jump instruction, wherein the jump instruction is configured to instruct the player to enable the target video to jump to a location indicated by the second time jump control to play.

6. The method according to claim 4, further comprising:
determining a corresponding video clip based on the selected second time jump control;
determining a corresponding video content summary based on the corresponding video clip;
generating a first list synchronization instruction based on the corresponding video content summary; and
executing the first list synchronization instruction, wherein the first list synchronization instruction is configured to instruct the video summary area to adjust the video summary list, so as to display the corresponding video content summary at a predetermined location of the video summary list.

7. The method according to claim 4, further comprising:
determining a corresponding video clip based on the selected first time jump control;
determining a subtitle of the corresponding video clip based on the corresponding video clip;
generating a second list synchronization instruction based on the subtitle of the corresponding video clip; and
executing the second list synchronization instruction, wherein the second list synchronization instruction is configured to instruct the video summary area to adjust the subtitle list, so as to display the subtitle of the corresponding video clip at a predetermined location of the subtitle list.

8. The method according to claim 2, wherein the frame image is determined based on the text summary, and the method further comprises:
determining a corresponding video clip based on the first time jump control of the text summary;
extracting a plurality of frame images based on the corresponding video clip;
determining text feature vectors of the plurality of frame images, and an image feature vector and an aesthetic score that are corresponding to each frame image;
determining a picture-text similarity corresponding to the each frame image based on the text feature vector and the image feature vector corresponding to the frame image; and
determining a target frame image based on the picture-text similarity and the aesthetic score that are corresponding to the each frame image, and determining the target frame image as the picture summary.

9. The method according to claim 8, wherein the determining text feature vectors of the plurality of frame images, and an image feature vector and an aesthetic score that are corresponding to each frame image comprises:
inputting the text summary into a pre-trained generative embeddings model, so as to obtain the text feature vectors by using the pre-trained generative embeddings model;
inputting the plurality of frame images into a pre-trained contrastive language-image model, so as to obtain the image feature vector corresponding to the each frame image by using the pre-trained contrastive language-image model; and
inputting the plurality of frame images into a pre-trained aesthetic scoring model, so as to obtain the aesthetic score corresponding to the each frame image by using the pre-trained aesthetic scoring model.

10. The method according to claim 1, wherein the player is further configured to display a playback progress bar of the target video, and the video summary area further comprises a progress bar linkage switch; and the method further comprises:
displaying a plurality of video summary nodes on the playback progress bar in response to turning on the progress bar linkage switch, wherein the plurality of video summary nodes are in one-to-one correspondence with the plurality of video clips;
determining a corresponding video clip in response to selecting one of the video summary nodes;
obtaining a corresponding video content summary based on the corresponding video clip; and
displaying the corresponding video content summary based on a display location of the selected video summary node.

11. The method according to claim 1, wherein the displaying a video summary area in response to selecting the video summary control comprises:
obtaining the video summary list and the subtitle list in response to selecting the video summary control;
when the video summary list and the subtitle list are obtained, displaying the video summary area, and displaying the video summary list and the subtitle list by using the video summary area; and
when the video summary list and the subtitle list are not obtained, obtaining a basic content list of the target video, wherein the basic content list comprises one or more of manuscript information, a comment, and a bullet-screen comment; and displaying the video summary area, and displaying the basic content list by using the video summary area.

12. A computer device, comprising:
at least one processor; and
a memory communicatively connected to the at least one processor, wherein
the memory stores instructions executed by the at least one processor, and the instructions are executed by the at least one processor to enable the at least one processor to perform the following steps:
displaying a playback page, wherein the playback page comprises a player and a video summary control, the player is configured to play a target video, and the target video comprises a plurality of video clips;
displaying a video summary area in response to selecting the video summary control, wherein the video summary area comprises a first display control; and
displaying a video summary list in the video summary area in response to selecting the first display control, wherein the video summary list comprises a plurality of video content summaries, and the plurality of video content summaries are in a one-to-one correspondence with the plurality of video clips;
wherein the video content summary comprises a text summary and a picture summary of a corresponding video clip, the picture summary comprises a frame image of the corresponding video clip, and the frame image is determined based on the text summary.

13. The computer device according to claim 12, wherein the video content summary further comprises a first time jump control; and the first time jump control and the text summary are obtained by performing the following operations:
obtaining text information of the target video, wherein the text information comprises a plurality of subtitles of the target video, and each subtitle has a corresponding time identifier; and
inputting the text information into a pre-trained language model, so as to obtain a plurality of text summaries by using the pre-trained language model;
wherein one text summary corresponds to one video clip, each text summary has a corresponding first time jump control, and the first time jump control is configured to locate a corresponding video clip of the text summary.

14. The computer device according to claim 13, wherein the at least one processor further performs the following the steps:
generating a jump instruction in response to selecting a first time jump control of one of the video content summaries; and
executing the jump instruction, wherein the jump instruction is configured to instruct the player to enable the target video to jump to a location indicated by the first time jump control to play.

15. The computer device according to claim 14, wherein the video summary area further comprises a second display control; and the method further comprises:
displaying a subtitle list in the video summary area in response to selecting the second display control, wherein the subtitle list comprises a plurality of subtitles of the target video and a second time jump control corresponding to each subtitle, and the second time jump control is configured to locate a corresponding video clip of the subtitle.

16. The computer device according to claim 15, wherein the at least one processor further performs the following the steps:
generating a jump instruction in response to selecting a second time jump control of one of the subtitles; and
executing the jump instruction, wherein the jump instruction is configured to instruct the player to enable the target video to jump to a location indicated by the second time jump control to play.

17. The computer device according to claim 15, wherein the at least one processor further performs the following the steps:
determining a corresponding video clip based on the selected second time jump control;
determining a corresponding video content summary based on the corresponding video clip;
generating a first list synchronization instruction based on the corresponding video content summary; and
executing the first list synchronization instruction, wherein the first list synchronization instruction is configured to instruct the video summary area to adjust the video summary list, so as to display the corresponding video content summary at a predetermined location of the video summary list.

18. The computer device according to claim 15, the at least one processor further performs the following the steps:
determining a corresponding video clip based on the selected first time jump control;
determining a subtitle of the corresponding video clip based on the corresponding video clip;
generating a second list synchronization instruction based on the subtitle of the corresponding video clip; and
executing the second list synchronization instruction, wherein the second list synchronization instruction is configured to instruct the video summary area to adjust the subtitle list, so as to display the subtitle of the corresponding video clip at a predetermined location of the subtitle list.

19. The computer device according to claim 13, wherein the frame image is determined based on the text summary, and the method further comprises:
determining a corresponding video clip based on the first time jump control of the text summary;
extracting a plurality of frame images based on the corresponding video clip;
determining text feature vectors of the plurality of frame images, and an image feature vector and an aesthetic score that are corresponding to each frame image;
determining a picture-text similarity corresponding to the each frame image based on the text feature vector and the image feature vector corresponding to the frame image; and
determining a target frame image based on the picture-text similarity and the aesthetic score that are corresponding to the each frame image, and determining the target frame image as the picture summary.

20. A computer program product, comprising a computer program, wherein when the computer program is executed by a processor, the following steps are implemented:
displaying a playback page, wherein the playback page comprises a player and a video summary control, the player is configured to play a target video, and the target video comprises a plurality of video clips;
displaying a video summary area in response to selecting the video summary control, wherein the video summary area comprises a first display control; and
displaying a video summary list in the video summary area in response to selecting the first display control, wherein the video summary list comprises a plurality of video content summaries, and the plurality of video content summaries are in a one-to-one correspondence with the plurality of video clips;
wherein the video content summary comprises a text summary and a picture summary of a corresponding video clip, the picture summary comprises a frame image of the corresponding video clip, and the frame image is determined based on the text summary.
